(19) United States
(12) Patent Application Publication
(10) Pub. No.: US 2023/0329279 A1
(43) Pub. Date: Oct. 19, 2023

(54) METHOD FOR PREPARING KONJAC GLUCOMANNAN GUM

(71) Applicant: Hefei University of Technology, Hefei (CN)

(72) Inventors: ZHAOMING WANG, Hefei (CN); HUI ZHOU, Hefei (CN); XINLIAN SU, Hefei (CN); BAOCAI XU, Hefei (CN); FEIRAN XU, Hefei (CN); KAI ZHOU, Hefei (CN); BAO ZHANG, Hefei (CN)

(21) Appl. No.: 18/119,520

(22) Filed: Mar. 9, 2023

(30) Foreign Application Priority Data
Apr. 13, 2022 (CN) 202210384638.4

(51) Int. Cl. A23G 3/42; A23G 3/48; A23L 33/175

(52) U.S. Cl. CPC A23G 3/42; A23G 3/48; A23L 33/175; A23G 2200/06

(57) ABSTRACT

Disclosed is a method for preparing konjac glucomannan gum. The method includes steps as follows: (1) preparing konjac sol; (2) preparing an amino acid solution by means of L-lysine and L-arginine; and (3) adding the amino acid solution into the konjac sol, and carrying out stirring, standing, and water-bath heating to obtain the konjac gum. According to the method for preparing konjac glucomannan gum in the present invention, the konjac glucomannan is modified by means of the L-lysine and the L-arginine according to a certain ratio, and hydroxyl ions in L-lysine and L-arginine solutions can remove acetyl groups in konjac glucomannan molecules under a heating condition such that thermostable gum can be formed, and properties of the konjac glucomannan gum are improved. According to the present invention, production processes for a konjac gum product are changed, and nutritional functions of the konjac product are added.

### CROSS-REFERENCE TO RELATED APPLICATIONS

This is a U.S. patent application which claims the priority and benefit of Chinese Patent Application Number 202210384638.4, filed on Apr. 13, 2022, the disclosure of which is incorporated herein by reference in its entirety.

### TECHNICAL FIELD

The present invention relates to the technical field of konjac food, and particularly to a method for preparing konjac gum.

### BACKGROUND

Konjac is also known as konnyaku, devilstongue, giantarum, leopard palm, etc. As a dominant component of konjac, konjac glucomannan (KGM) not only has excellent water-holding, rheological, thickening, gelling and film-forming properties, but also has long swelling time, poor sol stability and so on.

The konjac glucomannan can be modified through physical, chemical and biological methods. Alkali treatment for konjac glucomannan is one of the common methods to produce konjac products. Generally, alkaline reagents such as a sodium hydroxide solution, a calcium hydroxide solution and a sodium carbonate solution are added to modify the konjac glucomannan.

At present, konjac gum food is produced mainly by adding calcium hydroxide solutions. Moreover, in a production process, it is required to rinse excessive alkali with citric acid, so as to generate a large amount of acidic and alkaline waste water, thereby wasting plenty of water resources and extremely possibly polluting the environment.

Therefore, how to improve an existing method for producing konjac gum food has become one of the difficult problems to be urgently solved by researchers in the field.

### SUMMARY

The objective of the present invention is to provide a method for preparing konjac glucomannan gum. Through the method, acetyl groups of konjac glucomannan are removed by means of alkaline amino acids (L-lysine and L-arginine), and properties of the konjac glucomannan gum are effectively improved.

In order to realize the above objective, the present invention provides a technical solution as follows:

A method for preparing konjac glucomannan gum includes steps as follows:

(1) preparing konjac sol;

(2) preparing an amino acid solution by means of L-lysine and L-arginine; and

(3) adding the amino acid solution into the konjac sol, stirring to fully mix the amino acid solution and the konjac sol, and carrying out standing and water-bath heating to obtain the konjac gum.

The amino acid solution has a mass concentration of 2%, and a mass ratio of the L-lysine to the L-arginine is 1:1-4:1.

The step (1) specifically includes: dissolving konjac gum powder in drinking water, and heating to fully expand the konjac gum powder.

In the step (1), a mass ratio of the konjac gum powder to the drinking water is 2.5-3.5:100.

In the step (1), heating is carried out at 55° C.-65° C. for 30 min-60 min.

The step (3) specifically includes: adding the amino acid solution into the konjac sol, stirring to fully mix the amino acid solution and the konjac sol, placing the mixture in a culture dish for standing, placing the packaged mixture in a water bath kettle, and heating the mixture to prepare the konjac glucomannan gum.

In the step (3), a volume ratio of the amino acid solution to the konjac sol is 1:6.

In the step (3), standing is carried out for 1 h-3 h.

In the step (3), heating is carried out at 90° C.-95° C. for 1.5 h-3 h.

Compared with the prior art, the present invention has beneficial effects as follows:
according to the method for preparing konjac glucomannan gum in the present invention, the konjac glucomannan is modified by means of the L-lysine and the L-arginine according to a certain ratio, and hydroxyl ions in L-lysine and L-arginine solutions may remove acetyl groups in konjac glucomannan molecules under a heating condition such that thermostable gum may be formed, and properties of the konjac glucomannan gum are improved. According to the present invention, production processes for a konjac gum product are changed, and nutritional functions of the konjac product are added.

### BRIEF DESCRIPTION OF DRAWINGS

FIG. 1 is an infrared spectrogram of konjac glucomannan gum prepared by means of natural konjac glucomannan, L-lysine and L-arginine;

FIG. 2 shows water state distribution of konjac glucomannan gum treated with L-arginine solutions having concentrations of 1%, 2%, 3%, 4% and 5%, where KC is blank, and KA1, KA2, KA3, KA4 and KA5 are experimental results in cases of the L-arginine solutions having concentrations of 1%, 2%, 3%, 4% and 5% respectively;

FIG. 3 shows water state distribution of konjac glucomannan gum treated with L-lysine solutions having concentrations of 1%, 2%, 3%, 4% and 5%, where KC is blank, and KL1, KL2, KL3, KL4 and KL5 are experimental results in cases of the L-lysine solutions having concentrations of 1%, 2%, 3%, 4% and 5% respectively;

FIG. 4 is an electron microscope photograph of natural konjac glucomannan gum;

FIGS. 5-9 are electron microscope photographs of konjac glucomannan gum treated with L-arginine solutions having concentrations of 1%, 2%, 3%, 4% and 5% respectively;

FIGS. 10-14 are electron microscope photographs of konjac glucomannan gum treated with L-lysine solutions having concentrations of 1%, 2%, 3%, 4% and 5% respectively; and

FIG. 15 shows strength results of konjac glucomannan gum treated with arginine and lysine that have different volume ratios.

### DETAILED DESCRIPTION OF ILLUSTRATIVE EMBODIMENTS

Technical solutions in examples of the present invention will be clearly and completely described below in combination with accompanying drawings in examples of the present invention. Apparently, the described examples are merely some examples rather than all examples of the present invention. On the basis of examples of the present invention, all other examples obtained by those of ordinary skill in the art without making creative efforts fall within the scope of protection of the present invention.

Abbreviations involved have meanings as follows:
KGM: konjac glucomannan;
LYS: lysine; and
ARG: arginine.

A method for preparing konjac glucomannan gum includes steps as follows:
firstly, 9 g of konjac gum powder was dissolved in 300 mL of drinking water, and heated at 60° C. for 30 min to be fully expanded, so as to obtain konjac sol; an alkaline amino acid solution (L-lysine and/or L-arginine solution) having a mass fraction of 1%-5% was prepared; and
50 mL of the alkaline amino acid solution was added into the konjac sol (a volume ratio of the alkaline amino acid solution to the konjac sol is 1:6), the alkaline amino acid solution and the konjac sol were stirred to be fully mixed, the mixture was placed in a culture dish, vacuum-packaged, and subjected to standing for 2 h, and the packaged mixture was placed in a water bath kettle to be heated at 90° C. for 2 h to prepare the konjac glucomannan gum.

L-lysine solutions having different concentrations, L-arginine solutions having different concentrations, and L-lysine and L-arginine mixed solutions having different concentrations and ratios were used for experiments.

(1) Texture data of konjac glucomannan gum prepared by means of L-lysine solutions having different concentrations and L-arginine solutions having different concentrations are shown in Table 1.

TABLE 1
Texture data of konjac glucomannan gum treated with L-lysine and L-arginine

| | | Hardness | Elasticity | Cohesiveness | Chewiness |
|---|---|---|---|---|---|
| L-Lys | 1% | 389.78 ± 7.27 [symbol] | 0.90 ± 0.009 [symbol] | 0.57 ± 0.009 [symbol] | 199.39 ± 2.31 [symbol] |
| | 2% | 814.19 ± 18.21 [symbol] | 0.86 ± 0.002 [symbol] | 0.51 ± 0.005 [symbol] | 357.83 ± 5.10 [symbol] |
| | 3% | 1121.36 ± 21.71 [symbol] | 0.79 ± 0.007 [symbol] | 0.48 ± 0.005 [symbol] | 407.94 ± 8.99 [symbol] |
| | 4% | 1263.47 ± 23.64 [symbol] | 0.79 ± 0.008 [symbol] | 0.48 ± 0.005 [symbol] | 477.45 ± 12.33 [symbol] |
| | 5% | 1087.32 ± 78.29 [symbol] | 0.78 ± 0.01 [symbol] | 0.49 ± 0.004 [symbol] | 406.21 ± 40.67 [symbol] |
| L-Arg | 1% | 816.68 ± 5.42 [symbol] | 0.86 ± 0.019 [symbol] | 0.55 ± 0.018 [symbol] | 376.68 ± 22.23 [symbol] |
| | 2% | 1313.85 ± 72.74 [symbol] | 0.80 ± 0.006 [symbol] | 0.52 ± 0.006 [symbol] | 558.95 ± 83.95 [symbol] |
| | 3% | 1625.57 ± 13.72 [symbol] | 0.78 ± 0.004 [symbol] | 0.51 ± 0.001 [symbol] | 568.72 ± 148.13 [symbol] |
| | 4% | 1728.44 ± 62.62 [symbol] | 0.76 ± 0.009 [symbol] | 0.49 ± 0.004 [symbol] | 711.76 ± 42.50 [symbol] |
| | 5% | 1569.83 ± 17.42 [symbol] | 0.78 ± 0.002 [symbol] | 0.52 ± 0.004 [symbol] | 625.36 ± 16.13 [symbol] |

Note:
a, b and c indicate significance, the same letter indicates no significance, and different letters indicate significant differences. [symbol]
indicates data missing or illegible when filed

It can be seen from the above results that hardness and chewiness of konjac glucomannan gum treated with L-lysine or L-arginine are increased with the increase of concentrations, while elasticity and cohesiveness are not significantly decreased. However, hardness and chewiness of the gum are slightly decreased in the case of a concentration being 5%. Therefore, hardness and chewiness of konjac glucomannan gum may be effectively changed by means of L-lysine or L-arginine.

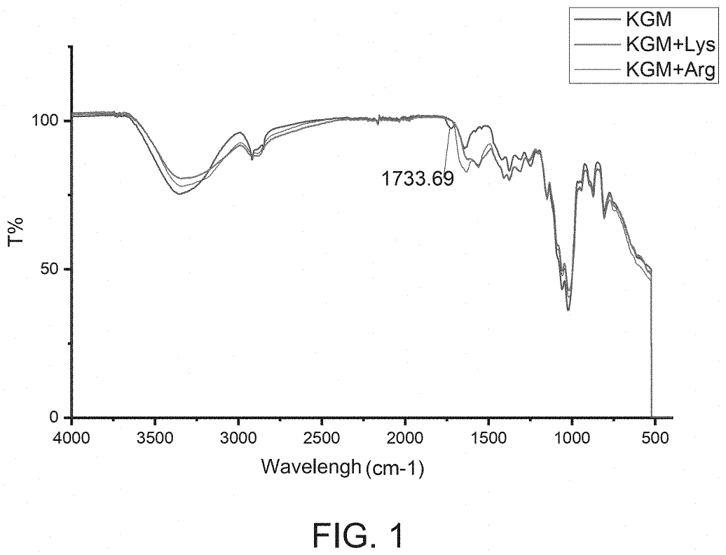

FIG. 1 is an infrared spectrogram of konjac glucomannan gum with acetyl groups prepared by means of natural konjac glucomannan, L-lysine and L-arginine. It can be seen that the acetyl groups in konjac glucomannan molecules are removed by the L-lysine and the L-arginine, and the gum is modified.

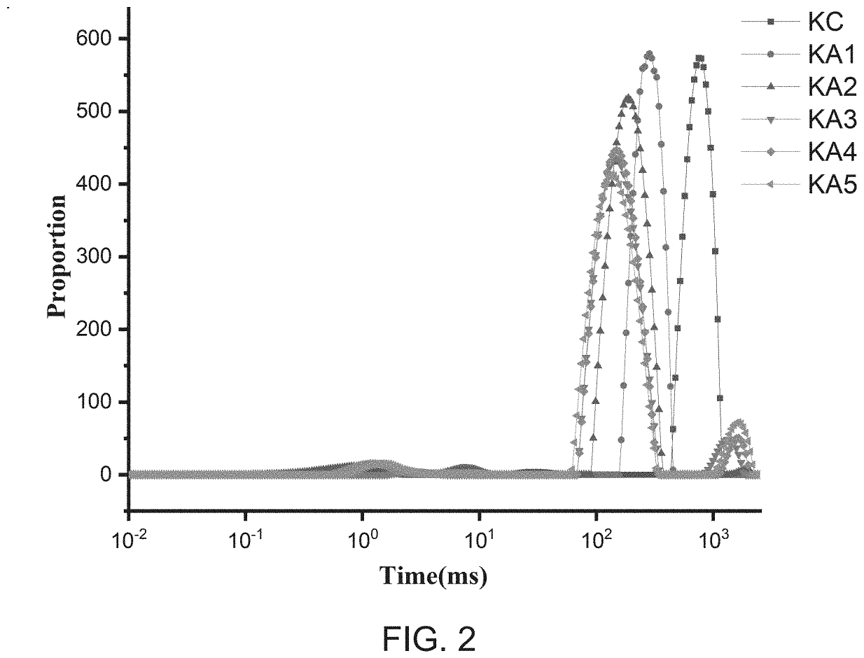

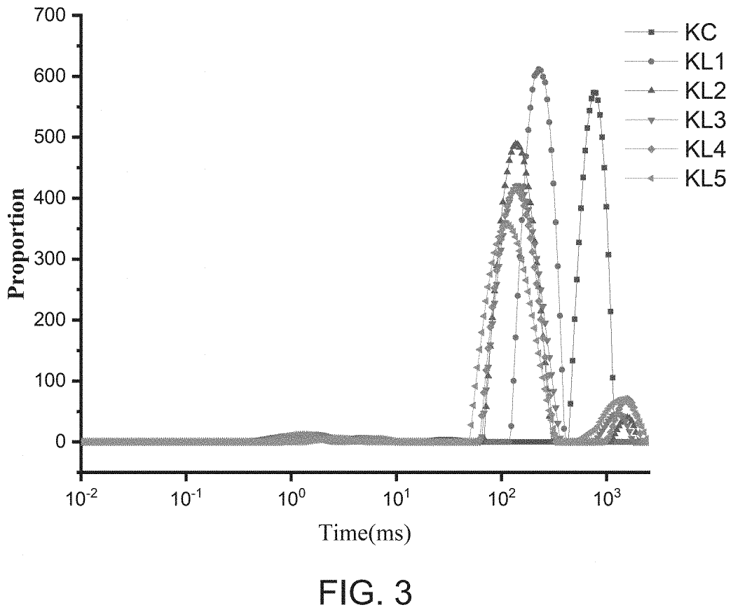

FIG. 2 shows water state distribution of konjac glucomannan gum treated with L-arginine solutions having concentrations of 1%, 2%, 3%, 4% and 5%, and FIG. 3 shows water state distribution of konjac glucomannan gum treated with L-lysine solutions having concentrations of 1%, 2%, 3%, 4% and 5%. It can be seen from the figures that water contents of the konjac gum treated with amino acids having different concentrations are different, and a water-holding property of the gum is affected. It can be seen from the results that there are three different water types, including (1) T21 (bound water) (1 ms-10 ms), (2) T22 (immobilized water) (100 ms-1000 ms) and (3) T23 (free water) (1000 ms-2500 ms). It can be clearly observed that an signal amplitude of T22 occupies an extremely large proportion, while signal amplitudes of T21 and T23 occupy extremely small proportions, which indicates that T22 is dominant. With the treatment of alkaline amino acids, the proportion of T22 is gradually decreased, while the proportion of T23 is increased, which indicates that the alkaline amino acids may cause a change in proportions of different water molecular components in a gum system. With the increase of concentrations of L-lysine and L-arginine solutions, the peak of T22 is blue-shifted. The number of peaks in a T21 region was increased. These results indicate that the gum forms a denser three-dimensional network.

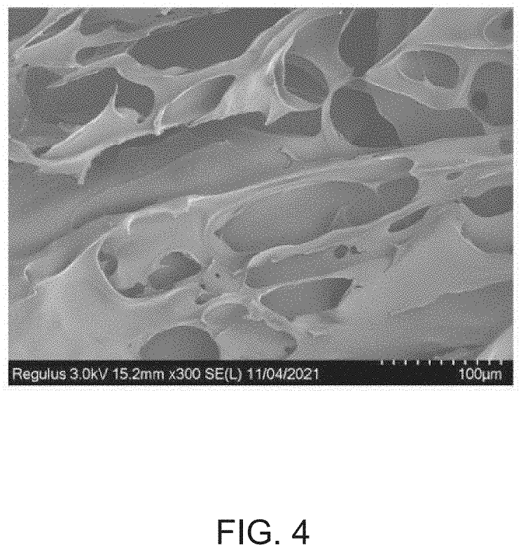

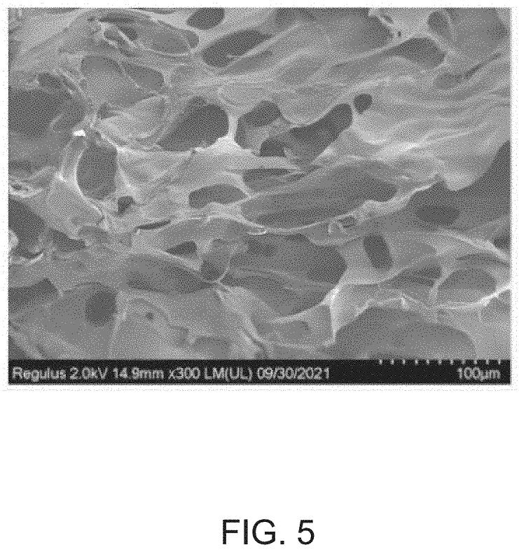

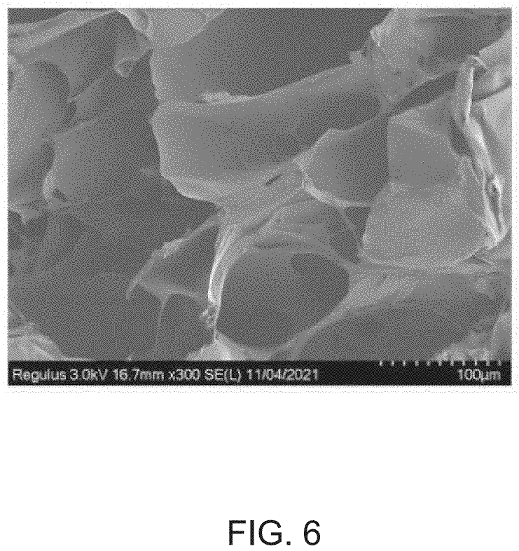

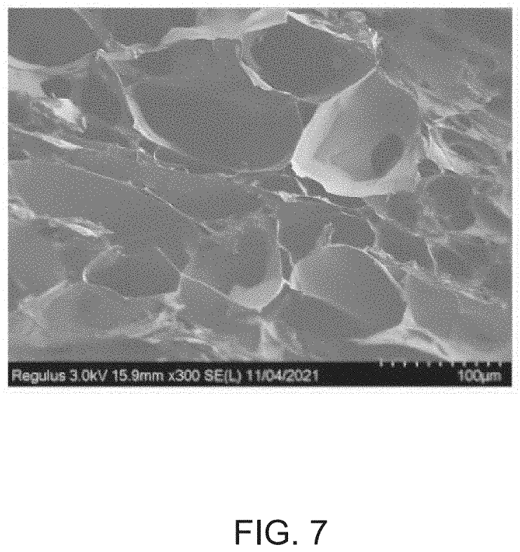

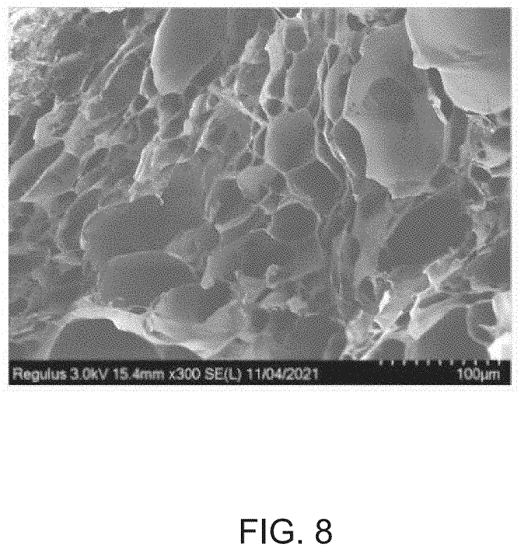

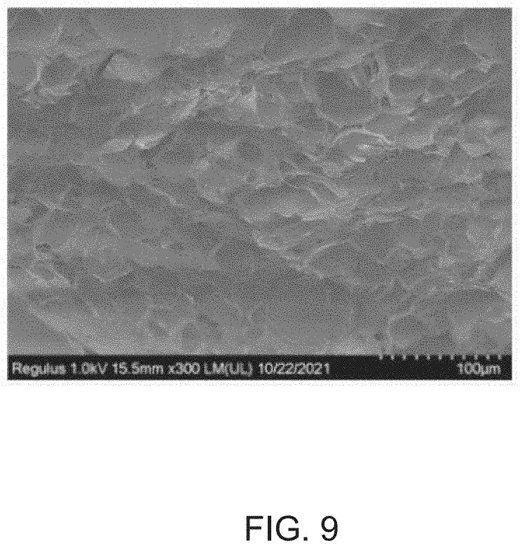

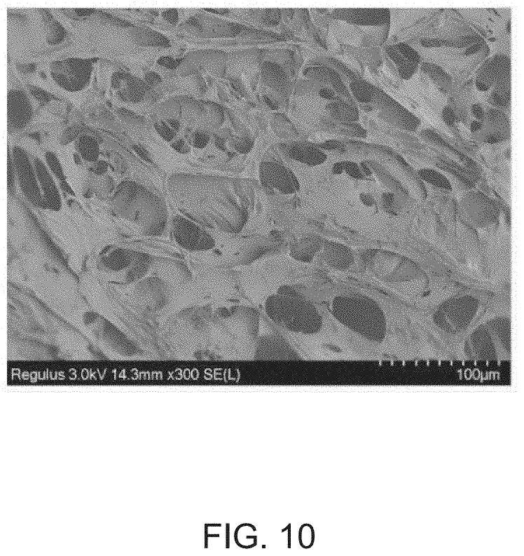

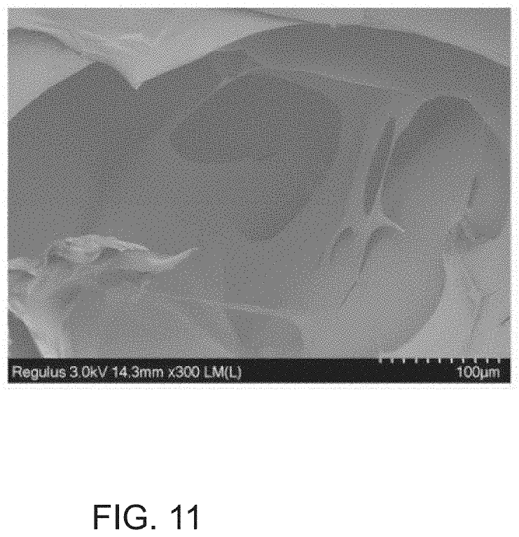

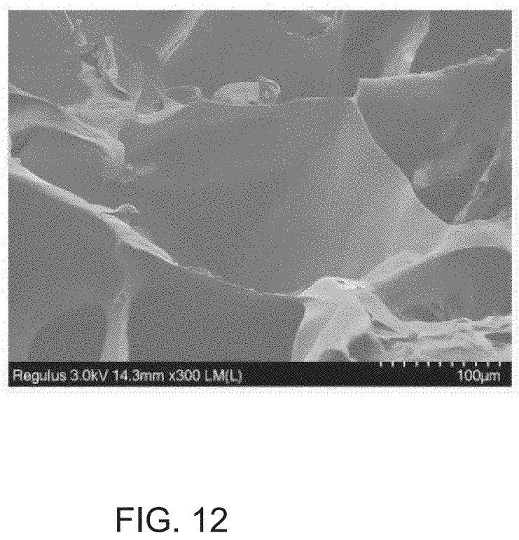

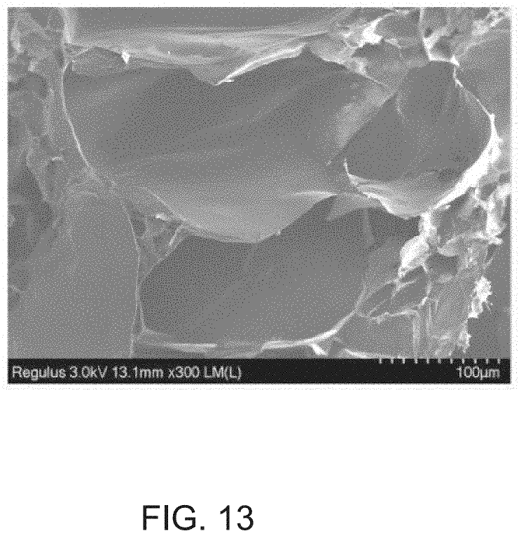

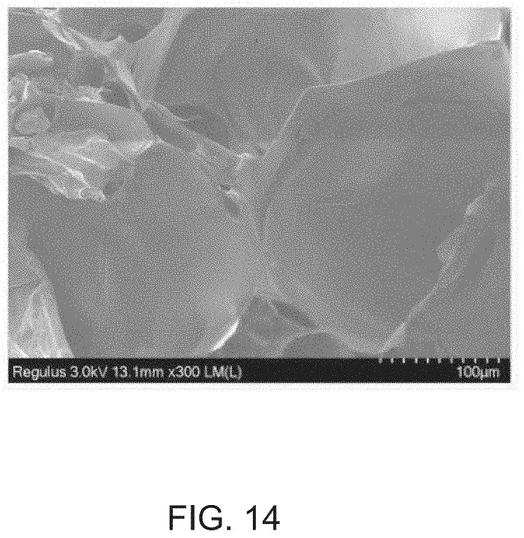

FIG. 4 is an electron microscope photograph of konjac glucomannan gum with acetyl groups. FIGS. 5-9 are electron microscope photographs of konjac glucomannan gum treated with L-arginine solutions having concentrations of 1%, 2%, 3%, 4% and 5% respectively. FIGS. 10-14 are electron microscope photographs of konjac glucomannan gum treated with L-lysine solutions having concentrations of 1%, 2%, 3%, 4% and 5% respectively. It can be seen from the above photographs that the konjac glucomannan gum prepared by means of the L-arginine or the L-lysine has a more uniform and compact network structure.

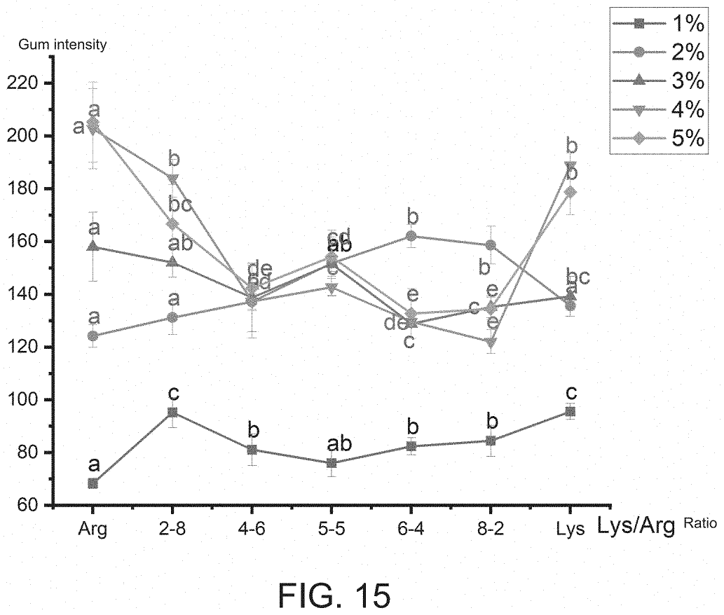

(2) Konjac glucomannan gum was prepared by means of L-lysine and L-arginine mixed solutions having different concentrations and ratios. Total concentrations of amino acids in the mixed solutions were set as 1%, 2%, 3%, 4% and 5% respectively, and ratios of L-lysine to L-arginine were set as 0:10, 2:8, 4:6, 5:5, 6:4, 8:2 and 10:0 respectively. Strength results of the prepared konjac glucomannan gum are as shown in FIG. 15.

It can be seen from the experimental results that strength of konjac glucomannan gum treated with lysine and arginine that have different volume ratios is significantly decreased in cases of total concentrations being 3%-5%, which proves that the lysine and the arginine have an antagonism action in cases of these concentrations and ratios. However, strength of konjac glucomannan gum treated with L-lysine and L-arginine (especially in the case of a mass ratio of the L-lysine to the L-arginine being 1:1-4:1) that have different volume ratios is significantly increased in the case of the total concentration being 2%, which indicates that the lysine and the arginine have a synergistic action in cases of these concentration and ratio ranges.

(3) In order to highlight the beneficial effects of the present invention, konjac glucomannan gum prepared by means of Ca(OH)₂ and Na₂CO₃ solutions having pH values similar to those of the lysine and the arginine is compared.

In a case where a pH value of L-LYS having concentrations of 1%-5% is about 10.22-10.28, gum strength ranges from 95 g-178 g.

In a case where a pH value of L-ARG having concentrations of 1%-5% is about 11.04-11.36, gum strength ranges from 68 g-205 g.

Therefore, Ca(OH)₂ and Na₂CO₃ solutions having pH values of 10, 10.5, 11 and 11.5 were prepared to determine strength of the konjac glucomannan gum treated with Ca(OH)₂ and Na₂CO₃, which is as shown in Table 2.

TABLE 2

Gum Intensity (g)

| pH | Ca(OH)₂ | Na₂CO₃ |
|---|---|---|
| 10 | 19.53 ± 0.57^{a} | 18.91 ± 1.53^{a} |
| 10.5 | 20.29 ± 0.55 [symbol] | 22.24 ± 2.33 [symbol] |
| 11 | 21.02 ± 1.25^{a} | 33.35 ± 3.07^{a} |
| 11.5 | 32.02 ± 2.47^{b} | 130.38 ± 15.07^{b} |

Note:
^{a}, ^{b} and c indicate significance, the same letter indicates no significance, and different letters indicate significant difference. [symbol]
indicates data missing or illegible when filed

It can be seen from the results in Table 1 and Table 2 that in the case of a pH value range being 10-11.5, the gum strength of the konjac glucomannan gum treated with Ca(OH)₂ is lower than that of the konjac glucomannan gum treated with L-Lys and L-Arg; and in cases of pH values being 10, 10.5 and 11, the gum strength of the konjac glucomannan gum treated with Na₂CO₃ is also lower than that of the konjac glucomannan gum treated with L-Lys and L-Arg. In the case of a pH value being 11.5, the gum strength is relatively high, and thermally irreversible gum is formed.

Therefore, thermally irreversible gum may be formed through treatment by means of the lysine and the arginine, and properties of konjac glucomannan gum are effectively improved. In addition, the preparing method in the present invention provide a novel method for processing a konjac product.

Although examples of the present invention are illustrated and described, it should be understood that those of ordinary skill in the art may make various changes, modifications, replacements and variations to the above examples without departing from the principle and spirit of the present invention, and the scope of the present invention is limited by the appended claims and equivalents thereof.

1. A method for preparing konjac glucomannan gum,
comprising steps as follows:
(1) preparing konjac sol;
(2) preparing an amino acid solution by means of L-lysine and L-arginine, wherein a total amount of the L-lysine and the L-arginine has a mass concentration of 2% in the amino acid solution, and a mass ratio of the L-lysine to the L-arginine is 1:1-4:1;
(3) adding the amino acid solution into the konjac sol;
(4) stirring to mix the amino acid solution and the konjac sol to obtain a mixture;
(5) carrying out standing the mixture; and
(6) water-bath heating the mixture to obtain the konjac glucomannan gum.

2. (canceled)

3. The method for preparing konjac glucomannan gum according to claim 1, wherein the step (1) comprises: dissolving konjac gum powder in drinking water, and heating the dissolved konjac gum powder in the drinking water to obtain the konjac sol.

4. The method for preparing konjac glucomannan gum according to claim 3, wherein in the step (1), a mass ratio of the konjac gum powder to the drinking water is 2.5-3.5:100.

5. The method for preparing konjac glucomannan gum according to claim 4, wherein in the step (1), heating is carried out at 55° C.-65° C. for 30 min-60 min.

6. The method for preparing konjac glucomannan gum according to claim 5, wherein the carrying out standing the mixture in the step (5) comprises: placing the mixture in a culture dish for standing, and
the water-bath heating the mixture in the step (6) comprises: packaging the mixture and placing the packaged mixture in a water bath kettle, and heating the packaged mixture to prepare the konjac glucomannan gum.

7. The method for preparing konjac glucomannan gum according to claim 6, wherein in the step (3), a volume ratio of the amino acid solution to the konjac sol is 1:6.

8. The method for preparing konjac glucomannan gum according to claim 7, wherein in the step (5), standing is carried out for 1 h-3 h.

9. The method for preparing konjac glucomannan gum according to claim 8, wherein in the step (6), heating is carried out at 90° C.-95° C. for 1.5 h-3 h.
